(19) United States
(12) Patent Application Publication
(10) Pub. No.: US 2006/0015409 A1
(43) Pub. Date: Jan. 19, 2006

(54) Delivery system, delivery apparatus and advertisement effect compilation method

(76) Inventors: Yumiko Kato, Neyagawa-shi (JP); Hideyuki Yoshida, Kyotanabe-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/532,676

(22) PCT Filed: Feb. 9, 2004
(86) PCT No.: PCT/JP04/01313

§ 371 Date: Apr. 26, 2005

(30) Foreign Application Priority Data
Feb. 21, 2003 (JP) 2003-044956

(51) Int. Cl. G06Q 30/00

(52) U.S. Cl. 705/26

(57) ABSTRACT

A broadcast system (10) includes a broadcast station (20) which broadcasts a program and a broadcast receiving apparatus (31a) which receives the program, wherein the broadcast receiving apparatus (31a) includes a microphone (32d) for marking a specific portion of the received program or an object that appears in the program, a voice recognition unit (107), a time/recognition result table storage unit (106), a transmission unit (108) which transmits tag history information indicating a history concerning the marking to the broadcast unit (20), a mobile terminal (40b) and the like, and the broadcast unit (20) includes an advertisement effect analysis unit (26) which performs an analysis for the program based on the tag history information transmitted from the broadcast receiving apparatus (31a), and a trend check program automatic generation/broadcast unit (27) which automatically generates a trench check program based on the result of the analysis.

### TECHNICAL FIELD

The present invention relates to a delivery system which delivers a program through television broadcasting and the like, in particular to a delivery system which analyzes information concerning the program based on information from viewers and the like.

### BACKGROUND ART

It is necessary to collect reactions of viewers to a program and commercial message (CM) that are delivered through television broadcasting and the like for making a program and studying details of a CM. Consequently, various techniques of collecting information concerning viewings of a program by viewers and providing the collected information to a sponsor and broadcast station of the program are suggested (e.g. refer to “viewer information collecting system” disclosed in Japanese Laid-Open Patent application No. 2002-344933).

The conventional viewer information collecting system is made up of a broadcast station, a broadcast receiving terminal, a viewing information server, and a viewer information use terminal. The broadcast station adds specific information relating to a CM program such as a sponsor code and a product name to a program data of the CM program and broadcasts it from a broadcasting system. The broadcast receiving terminal of a viewer receives the CM program, extracts the added specific information, and automatically transmits the extracted information to the viewing information server together with a viewing date, positional information, a pre-stored profile of the viewer and the like. The viewing information server compiles the viewing information received from the broadcasting receiving terminals into a database, at the same time, statistically analyzes the received viewing information so as to generate marketing information, and provides it to the viewing information use terminal. Thus, the viewer information collecting system automatically collects and processes information about “when, where, who, and with how much interests” the CM program is viewed, or about whether the CM program is associated with the product sales, and provides meaningful marketing information with value added to the sponsor and the broadcast station.

However, in the conventional viewer information collecting system, the broadcast station collects only viewing histories of a program by the viewer, profile information such as age of the viewer, and the like. It does not collect information focused on a scene and a shot which constitute the program, an object and the like such as a product used in the program (hereafter referred to as “object”), and information that the object is introduced to a third party (hereafter, the introduction of an object from a program viewer to a third party is referred to as “word-of-mouth”) and the like. Therefore, the conventional viewer information collecting system can only analyze general information for a program as a unit, and cannot analyze detailed information for, as a unit, a scene and shot which constitute the program, a product and the like used in the program. Also, it cannot count a ripple effect from a viewer to other viewers through a word-of-mouth.

For example, when a viewer is watching a program such as a drama, the viewer finds an interest in clothing which an actor wears and thinks wanting to tell about the clothing to a friend. Therefore, the viewer memorizes about the clothing in a part of his/her brain and tells his/her friend after the program is finished. Consequently, the friend who heard about the clothing may purchase the clothing because she liked it. However, in the conventional viewer information collecting system, following information are not collected: a fact that a product is introduced among viewers; a fact that the product becomes a topic among viewers; an indirect advertisement effect that the product introduced in the program is sold through an introduction by a viewer and the like. Therefore, items to be examined and analyzed at the broadcast station are limited and an advertisement effect of a product appeared in a program, topicality of the program and the like are not be able to be analyzed efficiently.

### DISCLOSURE OF INVENTION

Considering the situation, an object of the present invention is to provide a delivery system, delivery apparatus and advertisement effect compilation method thereof that can perform a detailed analysis for an advertisement effect on a product that appears in a program, a topicality of the program and the like, by collecting information concerning an interest of a viewer in the object appeared in the program and the like as a unit.

Also, another object of the present invention is to provide a delivery system, delivery apparatus and advertisement effect compilation method thereof that collect information about the fact that the object such as the product appeared in the program has been introduced among viewers, the fact that the object has been raised as a topic among viewers, an indirect advertisement effect that the product appeared in the program has been sold because of the introduction by the viewer, and the like, and can feed back the information to a sponsor of the program, a distributor of the product, the viewers and the like.

In order to achieve the objectives, a delivery system according to the present invention is the delivery system comprising a delivery apparatus which delivers a program and a receiving apparatus which receives the program, wherein said receiving apparatus includes: a tag unit operable to mark a specific portion of the received program or an object that appears in the program; and a first transmission unit operable to transmit, to said delivery apparatus, tag history information indicating a history concerning the marking by the tag unit, and said delivery apparatus includes: a first receiving unit operable to receive the tag history information transmitted from said receiving apparatus; and an analysis unit operable to perform an analysis for the program based on the tag history information received by said first receiving unit.

Consequently, the marking is performed on the specific portion of the program or the object that appears in the program and the history relating to the marking is collected to the delivery apparatus. Therefore, the delivery apparatus can perform not a general analysis/summarization for each program but an analysis/summarization concerning an interest of the viewer for each scene or shot that constitutes the program, object that appears in the program and the like.

In addition, it is not necessary that a transmission path for which the program is delivered and a transmission path for which the history relating to the marking is replied are the same. Therefore, a program making for viewers is realized, using an existing communication platform such as the broadcasting and the Internet as it is, and feeding back the responses from the viewers to the broadcast station and reflecting the feedback to a program contents production by distributing the program through a one-way broadcasting that is a one to many communication, and collecting the history relating to the marking via the Internet.

Here, said analysis unit counts frequency of the marking for each program or object based on the tag history information, and specifies a program or an object with a high marking frequency. Consequently, it can inquire popularity, topicality and the like in respect to the object as a unit.

Also, the delivery system further comprises a communication apparatus operable to communicate with said receiving apparatus via a communication network, wherein said receiving apparatus further includes a second transmission unit operable to transmit tag information that is information concerning the marked object to said communication apparatus. In addition, said first transmission unit further transmits, to said delivery apparatus, transmission history information indicating a history concerning the transmission of tag information to said communication apparatus by said second transmission unit, said first receiving unit further receives the transmission history information transmitted from said receiving apparatus, and said analysis unit counts frequency of the transmission of the tag information for each program or object, and specifies a program or an object with a high marking frequency.

Consequently, the tag information concerning the marking is transmitted to the third party and the information relating to the transmission is collected to the delivery apparatus. Therefore, information about the facts that the object such as the product appeared in the program has been introduced among viewers, and that the object has been raised as a topic among the viewers are collected so that the delivering side can grasp about ripple effect among the viewers caused by the delivery of the program.

Further, the delivery system further comprises a distributor apparatus which distributes online the object that appears in the program, said distributor apparatus being connected to said communication apparatus via the communication network, wherein said communication apparatus includes: a receiving unit operable to receive the tag information transmitted from said receiving apparatus; and a purchase unit operable to purchase the object by communicating with said distributor apparatus, according to information concerning the object included in the tag information received by said receiving unit. Then, said communication apparatus further includes a transmission unit operable to transmit purchase information concerning the purchase of the object to said delivery apparatus, said delivery apparatus further includes a second receiving unit operable to receive the purchase information transmitted from said communication apparatus, and said analysis unit judges i) whether or not the object has been purchased based on the tag information transmitted from said receiving apparatus, by collating the purchase information received by said second receiving unit with the transmission history information received by said first receiving unit, and ii) in the case where the object has been purchased based on the tag information, specifies a program or an object with high introduction effect by counting the frequency for each program or object.

Further, the information about mouth-to-word effect that the product appeared in the program is sold by the introduction from the viewer is collected to the delivery apparatus so that a detailed analysis including indirect advertisement effect can be performed.

Furthermore, said delivery apparatus may further comprises a program creation unit operable to create a program using a result of the analysis obtained by said analysis unit as a material, and deliver the created program. For example, the program creation unit creates the program by linking a previously produced program template and the result of the analysis.

Consequently, a program by which the sponsor of the program and the advertiser can obtain very useful information is produced. Accordingly, for example, a business model which provides paid useful marketing information based on the marking by the viewer can be constructed by making the program as a paid program for the sponsor of the program or corporations. Also, the viewer can know, in real time, a product or program with high topicality, and a trend or fashion about interests or preferences of other viewers, causing the viewer to count on watching the program.

Further, said second transmission unit, according to a receiving function of said communication apparatus, may select only a portion of the tag information, and transmit the selected information to said communication apparatus. Said second transmission unit may convert a format of data, from one of a moving picture, a still picture, voice and text to another one of the formats, in accordance to the receiving function of said communication apparatus, the data being included in the tag information.

Consequently, preceding to the transmission of the tag information, the receiving apparatus, in accordance with the receiving capability of the destination, narrows down transmission information or converts a format of data so that a communication waste that useless data which the destination cannot process to be transmitted is avoided.

In addition, said communication apparatus may further include: a selection unit operable to select only a portion of the tag information received by said receiving unit, according to functions concerning a display output and voice reproduction of said communication apparatus; and a presentation unit operable to output the selected tag information for display or reproduce the selected tag information in voice. Also, said selection unit may further convert a format of data, from one of a moving picture, a still picture, voice and text to another one of the formats, in accordance to the functions concerning the display output or voice reproduction of said communication apparatus, the data being included in the tag information received by said receiving unit.

Consequently, even in the case where the received tag information includes data in a format which the communication apparatus cannot process, available data for processing is only selected and outputted for display or outputted for display after being converted to data in a format which can be processed so that a process of selecting the transmission information and a process of converting data by the receiving apparatus at the side of transmitting the tag information become unnecessary.

As described in the above, the delivery system according to the present invention can analyze not only for direct advertisement effect but also for indirect advertisement effect such as a topicality among the viewers or a purchase of the product by the introduction from the viewer, and the analysis result is delivered as a trend check program. Therefore, very useful marking information is provided not only for the viewers but also for the producer and sponsor of the program and the like. It can be said that the practical value is very high.

Note that, the present invention can be embodied not only as such delivery system but also as a delivery apparatus which constitutes the delivery system, a communication apparatus unit, an advertisement effect compilation method having, as steps, the characteristic constituents which constitutes the delivery system, or as a program for a computer to execute such method. In addition, it is needless to say that such program can be delivered via a transmission medium such as the Internet or a recording medium such as CD-ROM.

### BRIEF DESCRIPTION OF DRAWINGS

FIG. 1 is a diagram showing an overall structure of a broadcast system which is an example of a delivery system according to the present invention.

FIG. 2 is an outside drawing of a remote controller.

FIG. 3 is a diagram showing a flow of main information in the broadcast system.

FIG. 4 is a diagram showing a data structure of broadcast data of program additional information attached program broadcasted from a broadcast station.

FIG. 5 is a diagram showing a data structure indicating details of content information included in the program additional information to be transmitted from the broadcast station.

FIG. 6 is a diagram showing a specific example of the program additional information shown in FIG. 5.

FIG. 7 is a functional block diagram showing a detailed structure of a broadcast receiving apparatus in the broadcast system.

FIG. 8 is a diagram showing a data structure of a time/recognition result table storage unit of the broadcast receiving apparatus.

FIG. 9 is a diagram showing a data structure of a destination database of the broadcast receiving apparatus.

FIG. 10 is a functional block diagram showing a structure of a transmission unit of the broadcast receiving apparatus.

FIG. 11 is a functional block diagram showing a detailed structure of an information filter in the transmission unit of the broadcast receiving apparatus.

FIG. 12 is a flowchart showing an operating procedure of the broadcast receiving apparatus.

FIG. 13 is a diagram showing a state of conversation between the broadcast receiving apparatus and a viewer.

FIG. 14 is a functional block diagram showing a structure of a mobile terminal in the broadcast system.

FIG. 15 is a flowchart showing an operating procedure of the mobile terminal.

FIG. 16 is a diagram showing a state of conversation between the mobile terminal and an operator.

FIG. 17 is a diagram showing a screen display example (moving picture, etc.) at the mobile terminal.

FIG. 18 is a diagram showing a screen display example (highlight display of video) at the mobile terminal.

FIG. 19 is a diagram showing a structure of the broadcast station in the broadcast system and peripheral apparatuses.

FIG. 20A is a diagram indicating a data structure of a tag history/transmission history directly transmitted from the viewer (broadcast receiving apparatus).

FIG. 20B is a diagram indicating a data structure of ordering information transmitted from a purchaser (mobile terminal) who purchased a product via a distributor.

FIG. 21 is a diagram showing an analysis table indicating types of analysis performed by an advertisement effect analysis unit of the broadcast station.

FIG. 22 is a flowchart showing a procedure concerning the analysis for an advertisement effect by the broadcast station.

FIG. 23 is a flowchart showing a procedure of automatically generating a trend check program by the broadcast station.

FIG. 24 is a diagram showing a data structure of a trend check program which is automatically generated by the broadcast station.

FIG. 25 are diagrams showing examples of displaying a program generated by the trend check program automatic generation/broadcast unit of the broadcast station.

### BEST MODE FOR CARRYING OUT THE INVENTION

Hereafter, it is explained in detail about an embodiment of the present invention with references to drawings.

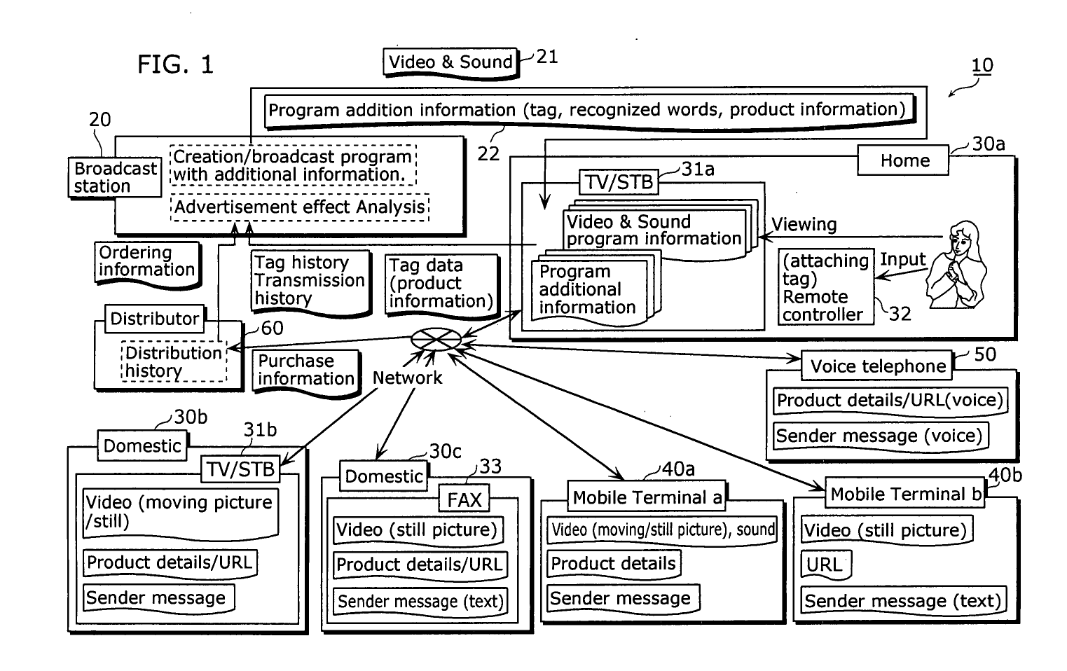

FIG. 1 is a diagram showing an overall structure of a broadcasting system 10 which is an example of a delivery system according to the present invention. The broadcasting system 10 is a television broadcasting system, when a viewer finds an interested object while watching a program, which can automatically transmit information relating to the object and the like to a friend and the like by a simple marking process such as pushing a button on a remote control (hereafter, such process is called as “attaching a tag”). It is made up of a broadcast station 20, a broadcast receiving apparatus (TV/STB) set in each of homes 30a to 30c, a remote controller 32, a FAX 33, mobile terminals 40a and 40b, a floor type telephone 50, and a distributor 60. Here, the broadcast station 20 and the broadcast receiving apparatuses 31a and 31b are connected via a CATV network and the like, and can communicate in two-ways. The broadcast receiving apparatuses 31a and 31b, the FAX 33, the mobile terminals 40a and 40b, the floor type telephone 50 and the distributor 60 are connected to a communication network such as a telephone network.

The broadcast station 20 is a broadcast station which creates and broadcasts a program with program additional information attached and the like. Here, the program additional information 22 is additional data to be multiplexed together with video and sound 21 and transmitted, including product information which describes detailed information relating to a product introduced in the video, information specifying the video and the like in accordance with a Moving Picture Expert Group (MPEG)-7. The broadcast station 20 not only broadcasts the program but also collects various information (transmission history, tag history, order information, etc, that are explained later) from the viewer and the distributor 60 which receives an order of the program from the viewer, analyzes an advertisement effect for a program or the object introduced in the program as a unit based on the collected information, provides the analysis result to the viewer and the distributor 60 and uses as a program material so as to automatically generate a new program called “trend check”.

The broadcast receiving apparatuses 31a and 31b are a television receiving set or a two-way broadcast receiver as a Set Top Box (STB) used attaching to the television receiving set. According to an instruction of the viewer, while attaching a tag to the object introduced in the program, it can transmit information relating to the object to which a tag is attached (hereafter referred to as “tag information”) to a specified address, or transmit a history relating to a transmission of the tag information (hereafter referred to as “transmission history”) to the broadcast station 20.

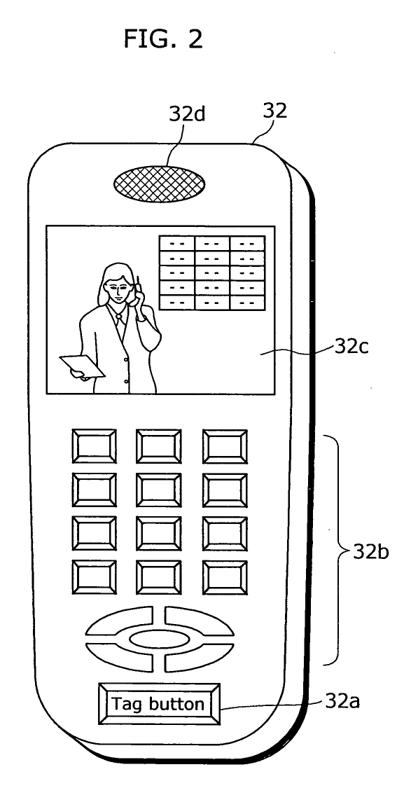

The remote controller 32 is a remote control which operates the broadcast receiving apparatus 31a from a distant. It has a function as a user interface for attaching a tag. That is, as shown in FIG. 2, the remote controller 32 includes, other than general operation buttons 32b, a tag button 32a for attaching a tag, when an object such as an interested product is found while watching a program, to the video or the object, a display screen 32c on which a program transmitted from the broadcast receiving apparatus 31a and a picture for user interface are displayed, and a microphone 32d for giving an audio instruction to the broadcast receiving apparatus 31a.

The FAX 33 is a facsimile receiver which receives pictures and the like. The mobile terminals 40a and 40b are a mobile phone, a Personal Digital Assistant (PDA) and the like that are available for data communication via the Internet. The floor type telephone 50 is a telephone which is available only for voice conversation without a function for data communication.

The distributor 60 is a web site which sells a product introduced in the program through an online shopping and informs the broadcast station 20 of the purchase information and the like as ordering information.

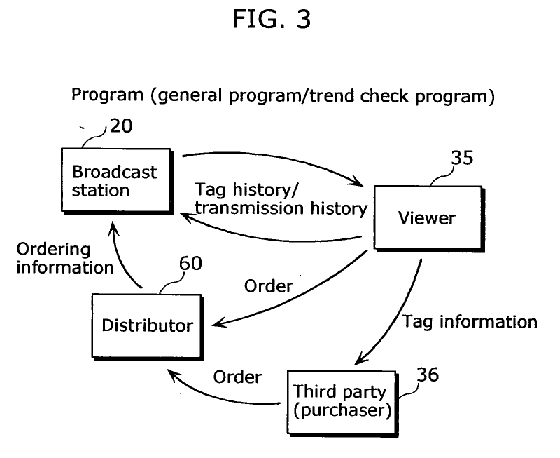

FIG. 3 is a diagram showing a main flow of information in the broadcasting system 10 structured as described in the above.

A viewer 35 attaches a tag when finding an interest in a product introduced in the program while watching the program broadcasted from the broadcast station 20. Then, when the program is ended or the like, the viewer orders the product to the distributor 60 through the online shopping and the like, and transmits information relating to the product as tag information to a third party 36 (those who use the broadcast receiving apparatus 31b, the FAX 33, the mobile terminals 40a and 40b, and the floor type telephone 50 shown in FIG. 1), after verifying information of the program to which a tag is attached while watching the program. Here, the broadcast receiving apparatus 31a used by the viewer 35 i) stores that the viewer 35 attached a tag while watching the program and that the viewer 35 transmits the tag information to the third party 36 into the inside memory and the like respectively as a tag history and a transmission history, and ii) transmits to the broadcast station 20 when the instruction by the viewer 35 is received or after a certain period is passed.

When the third party 36 who received the tag information likes the product included in the information, the third party 36 accesses to a Uniform Resource Locator (URL) and the like included in the information using an Internet browser and the like installed by the mobile terminal 40b and the like, and orders the product to the distributor 60. Herein, not only the purchase information for specifying the product, but also the information indicating that it is an order based on the tag information transmitted from the viewer 35 is transmitted to the distributor 60.

The distributor 60 which received the purchase information and the like performs an order and informs the broadcast station 20 of the purchase information and the like as the order information. Herein, the information obtained from the purchaser (information indicating that the product is introduced from other viewers and the like) is also informed.

The broadcast station 20 collects tag history and transmission history to be transmitted from the viewer 35 and the order information to be transmitted from the distributor 60 and analyzes the collected information in order to count various advertisement effects based on the attachments of tags by the viewer 35. Then, the broadcast station 20 automatically generates the program by using the analysis result as a material of a “trend check” program, broadcasts and provides information (feedback) to the viewer 35 and the distributor 60.

Hereafter, it is explained about a detailed structure of a broadcast data to be transmitted from the broadcast station 20, a detailed process of the broadcast receiving apparatus 31, and the like.

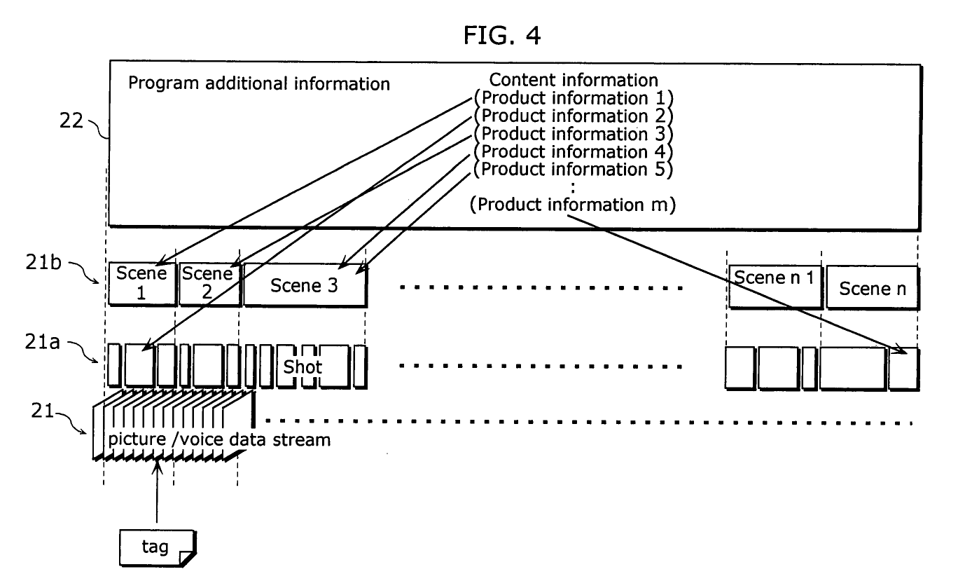

FIG. 4 is a diagram showing a data structure of broadcast data of a program to which program additional information is attached and to be broadcasted from the broadcast station 20. The broadcast data is mainly made up of a data stream 21 of picture and voice, and program additional information 22. The picture/voice data stream 21 is main information which constitutes a program and a commercial message, and is composed of a set of scenes 21b corresponding to a situation, each of the scenes 21b is composed of a set of shots 21a, each of which is cut for each movement of a shooting camera, and each shot 21a is composed of a set of frame pictures.

The program additional information 22 is a data stream which is multiplexed with a picture/voice stream 21. In the present embodiment, it includes content information which is a collection of product information, each of which is information relating to a product introduced in the program. Each of the product information 1 to m included in the content information is one of the information transmitted to other apparatuses from the broadcast receiving apparatus 31a via a network to other apparatuses and associated with a scene and shot in which the product is appeared. This is for the viewer to be able to verify the product appeared in the scene and the short from the scenes and shots to which the viewer attached tags.

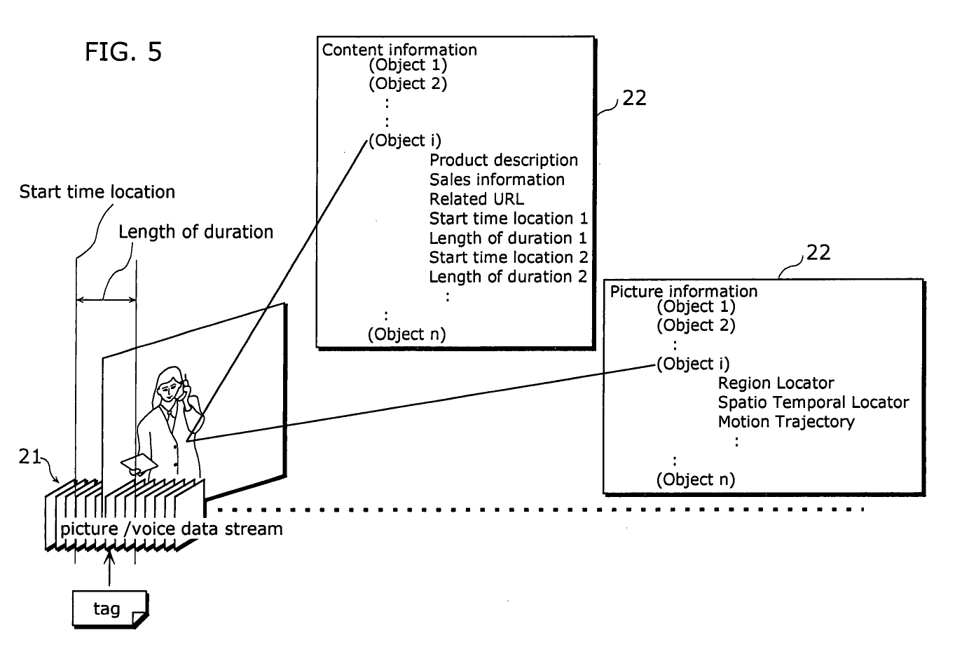

FIG. 5 is a data structure diagram showing details of the content information included in the program additional information 22 transmitted from the broadcast station 20. The content information includes detailed information for each object in the case where each commodity (product) is categorized into objects 1 to n. As detailed information for each object, followings are included: name and production company of the product, product description indicating size, color, material and the like, sales information indicating a sales price, a distributor and the like, a related URL indicating an address of a web site relating to the product (i.e. information source address of the product), a start time position which is a time location in the program when the product is appeared and a length of duration indicating the length for which the product is presented.

Also, the program additional information 22 includes picture information (lower right in FIG. 5) for specifying a spatial position in a frame picture of the specified each of the objects 1 to n. The picture information is used for categorizing each of the products displayed at the same time location in the program. Note that, as information for specifying a spatial location of the object, a coordinate, shape, movement path and the like in the frame picture are used.

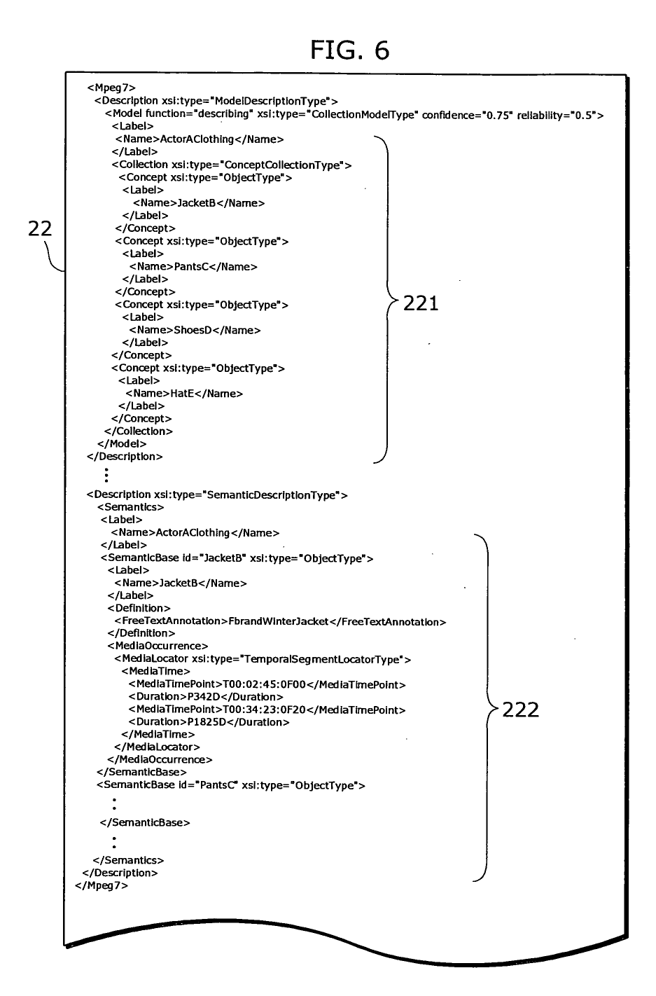

FIG. 6 is a diagram showing a specific example of the program additional information 22 shown in FIG. 5. Here, it is shown examples that each tag adhere to the MPEG 7 declares objects appeared in the program as shown in the first portion 221 and that the product description and time location of each object are described as shown in the latter portion 222. Specifically, in the first portion 221, as clothing of an actor A in the program, four objects “jacket B”, “pants C”, “shoes D”, and “hat E” are declared. In the latter portion 222, it is described the “jacket B” whose product description is “winter jacket from brand F”, whose start time location 1 is “T00:02:45:0F00”, the duration time length 1 is “P342D”, the start time location 2 is “T00:34:23:0F20”, and the duration time length 2 is “P1825D”.

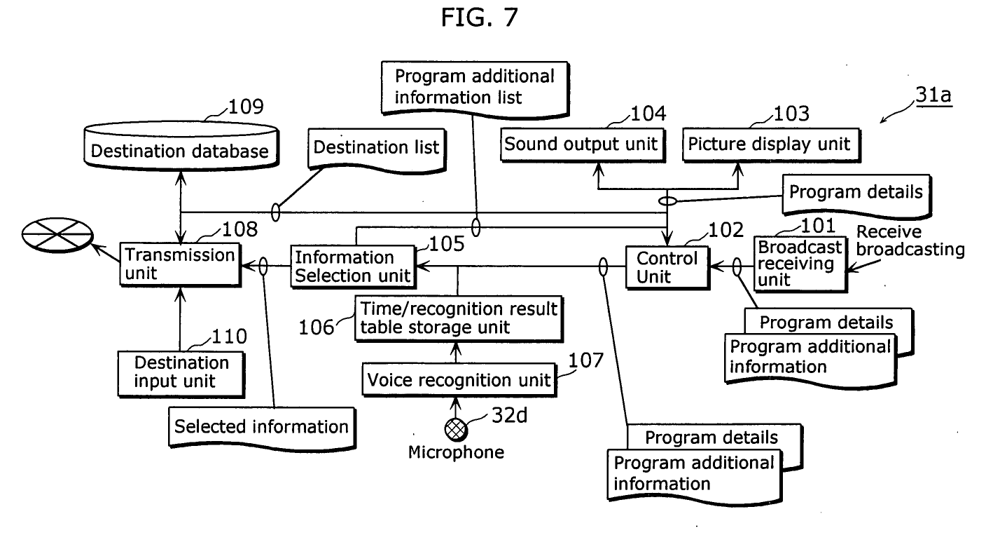

FIG. 7 is a functional block diagram showing a detailed structure of the broadcast receiving apparatus 31a shown in FIG. 1. The broadcast receiving apparatus 31a is a television broadcast receiver which allows a viewer to attach a tag to a received video and transmit each information applied to the tag to outside, for each object as a unit (here, it is a product appeared in the program). It includes a broadcast receiving unit 101, a control unit 102, a picture display unit 103, a sound output unit 104, an information selection unit 105, a time/recognition result table storage unit 106, a voice recognition unit 107, a microphone 32d, a transmission unit 108, a destination database 109, and a destination input unit 110.

The broadcast receiving unit 101 is a receiving circuit which receives broadcast data broadcasted from the broadcast station 20, a Transport Stream (TS) decoder and the like. It demultiplexes the received broadcast data into program details composed of the video/sound stream and program additional information and transmits to the control unit 102.

The picture display unit 103 is a display on which program details, operational screen for communicating the broadcast receiving apparatus 31a with the viewer and the like, or a display screen 32c and the like set on the remote controller 32. The sound output unit 104 is a speaker and the like which outputs voice and sound which composes the program details.

The control unit is a CPU, a storage apparatus and the like which temporally holds the program details (video/sound stream) received by the broadcast receiving unit 101, transmits the stored program details and the program additional information to the information selection unit 105 in response to a request from the information selection unit 105, transmits the stored program details and program additional information to the information selection unit 105 and controls each constituent in order to communicate with the viewer.

When a voice of the viewer is transmitted through the microphone 32d, the voice recognition unit 107 recognizes the time herein (time stamp) with reference to an installed timer, histories information for identifying the program (program identification information) with reference to information indicating the selected program, and recognizes the transmitted voice. It recognizes the voice of the viewer, performs language process, analyzes the meanings, and stores the program identification information which identifies the program viewed therein in association with the recognition result information indicating the recognition result and the time information indicating the recorded time, into the time/recognition result table storage unit 106.

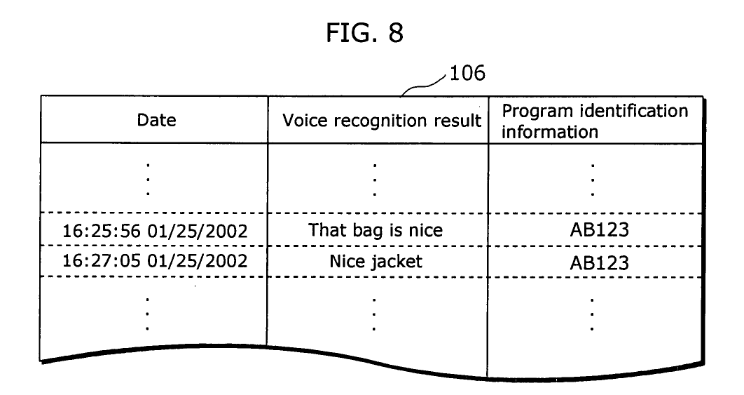

The time/recognition result table storage unit 106 is a memory and the like which temporary stores the recognition result information and program identification information transmitted from the voice recognition unit 107. For example, as shown in FIG. 8, it has a data structure in which the date when the viewer communicated, the recognition result of the voice, and program identification information which identifies the program which is viewed therein are associated with each other and stored.

The information selection unit 105 i) reads the time information, recognition result information and program identification information that are stored in the time/recognition result table storage unit 106 after the program is viewed or the program is stopped while being viewed, and ii) obtains the program additional information corresponding to before and after the program video including the program video indicated in the read program identification information and the time information from the control unit 102. Then, it extracts product information corresponding to the recognition result information from the obtained program additional information, and outputs the extracted product information as the program additional information list to display to the picture display unit 103 so as to encourage the viewer to verify. When the verification is obtained, it reads the picture shot and voice including the product information from the control unit 102, and transmits the product information, picture shot and voice as tag information to the transmission unit 108.

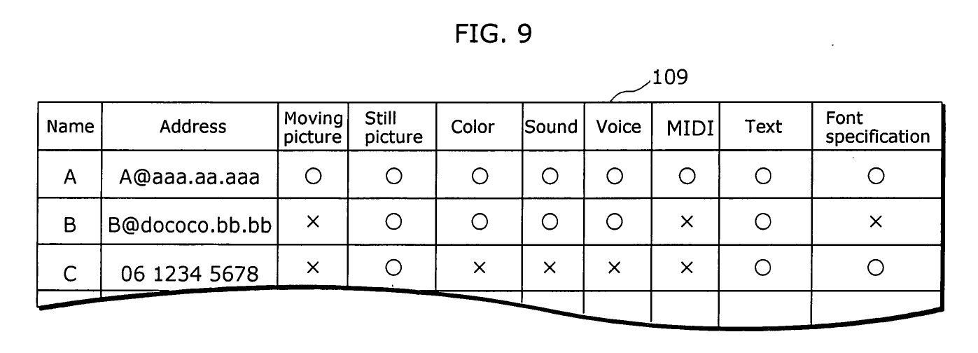

As shown in FIG. 9, the destination database 109 is a memory card and the like which hold information of a destination which is a destination of transmitting the tag information. In FIG. 9, an example of the destination database 109 which is made up of attribute items (“moving picture”, “still picture”, “color”, “sound”, “voice”, “MIDI”, “text”, “found specification”) showing whether or not the “title” and “address” of the destination and the apparatus connected to the destination can be processed or not. Here, for example, “◯” in a portion of the “moving picture” indicates that the apparatus at the destination has a function of processing (displaying) a moving picture, and “◯” in a portion of the “fount specification” indicates that the apparatus at the destination receives a font specification and displays various fount characters (or print output).

The destination input unit 110 is an input unit for the viewer to select a destination of the tag information from the destination database 109 or directly input the address of the tag information. It includes not only the operation buttons 32b on the remote controller 32 but also the microphone 32d installed in the remote controller 32 and a recognition processing apparatus for the voice inputted to the microphone 32d.

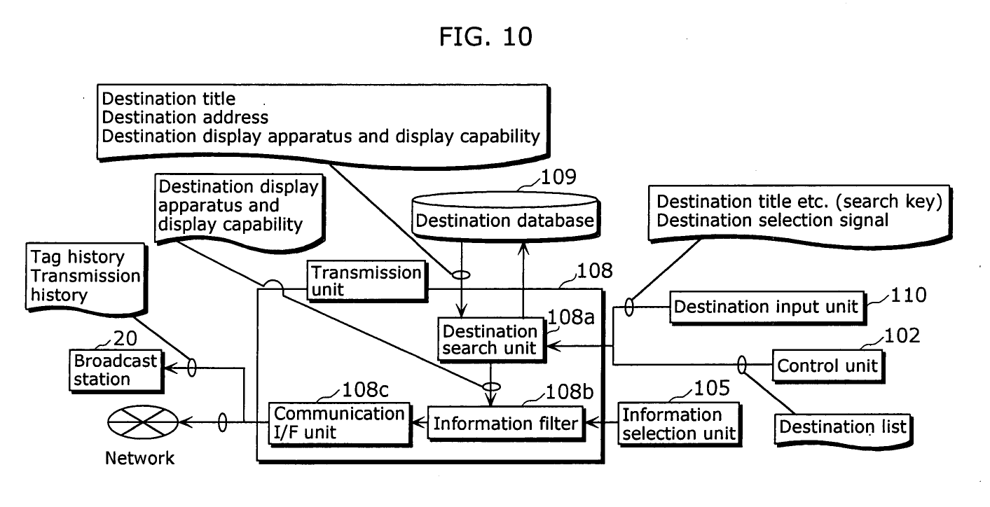

The transmission unit 108 is a processing unit which transmits, via a network, the tag information sent from the information selection unit 105 to the destination specified by the viewer. As shown in FIG. 10, it is made up of a destination search unit 108a, an information filter 108b, and a communication interface (I/F) unit 108c.

The destination search unit 108a i) allows the control unit to display a list of destinations to the picture display unit 103 and obtains a destination specified by the viewer to the listed display via the destination input unit 110 by reading the “destination” from the destination database 109 and transmitting to the control unit 102, or ii) specifies the destination, reads information of the specified destination (address, appliances attributes such as display capability etc.) and transmits to the information filter 108b by obtaining a search key such as destination title as a destination selection signal and searching in the destination database 109 based on the search key.

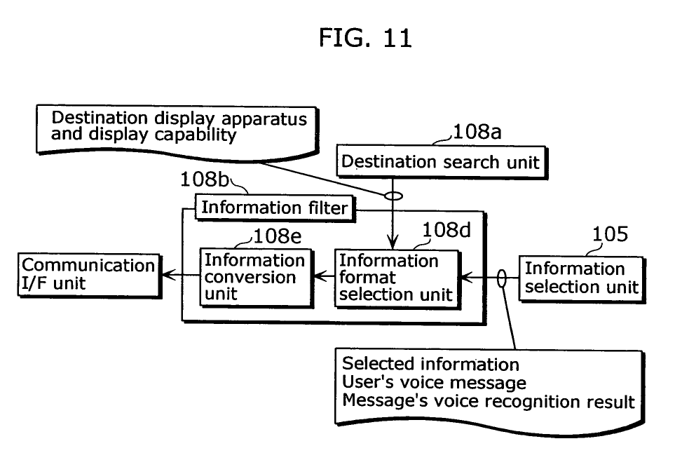

As shown in FIG. 11, the information filter 108b is made up of an information format selection unit 108d which selects tag information sent from the information selection unit 105 based on the apparatus attribute sent from the destination search unit 108a and an information conversion unit 108e which converts the information format selected by the information format selection unit 108d into a format which an appliance at the destination can use.

For example, in the case where a moving picture and a still picture are included in the tag information sent from the information selection unit 105 and the appliance attribute sent from the destination search unit 108a indicates that only the still picture can be used (“moving picture” column indicates “X” and “still picture” column indicates “◯”), the information format selection unit 108d selects only the still picture. Also, in the case where a voice message inputted by the viewer is included in the tag information sent from the information selection unit 105 and the appliance attribute sent from the destination search unit 108a indicates that text can be used but the voice cannot be used (“text” column indicates “◯” and “voice” column indicates “X”), the information format selection unit 108d transmits the voice message together with the notification to the information conversion unit 108e and the information conversion unit 108e converts the voice message into a text message.

The communication I/F unit 108c is a communication interface such as a modem which transmits the tag information sent from the information filter 108b to the included “address” via the network.

Here, the transmission unit 108 has a function of transmitting the tag history and the transmission history to the broadcast station 20 in addition to a function of transmitting such tag information to the third party. That is, the transmission unit 108, every time when detecting a transmission instruction from the viewer or a pass of a certain period (e.g. every first day of the month), reads out information accumulated in the time/recognition result table storage unit 106 via the information selection unit 105, transmits the read information to the broadcast station 20 as the tag history, and transmits information indicating that the tag information has been transmitted to the third party (information concerning a destination and a tagged object (broadcast date, identification information of program, object name etc)) to the broadcast station 20 as the transmission history.

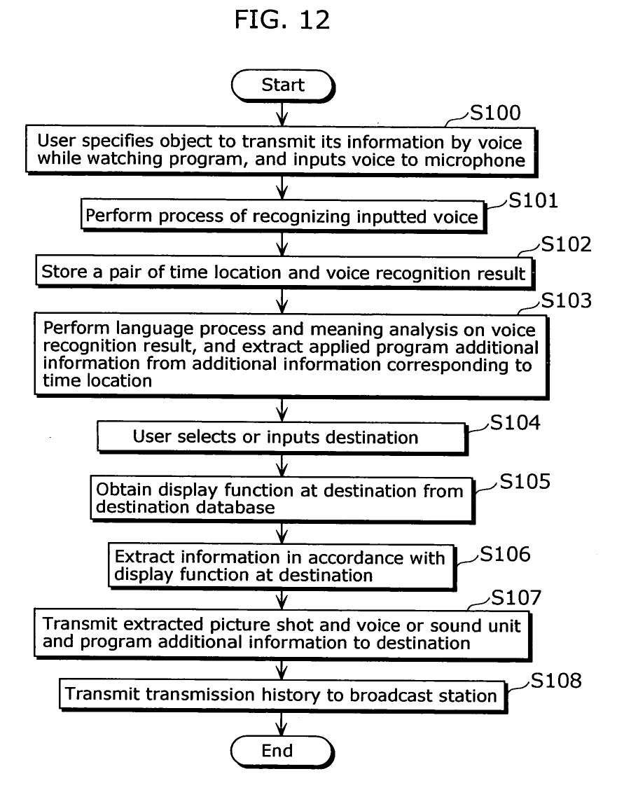

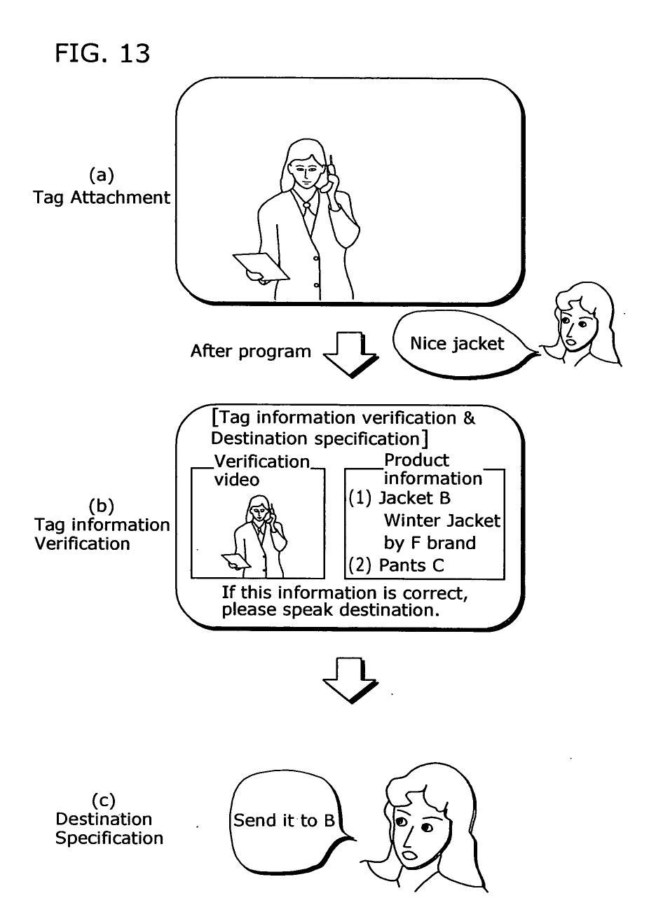

FIG. 12 is a flowchart showing an operating procedure of the broadcast receiving apparatus 31a which is structured as above described. FIG. 13 is a diagram showing a state of a communication between the viewer and the broadcast receiving apparatus 31a.

As shown in FIG. 13 (a), suppose the viewer now sounds voice including a name of an object that appears in a program while watching the program (S100). For example, the viewer who was watching a scene in which an actor A plays liked a red jacket which the actor A puts on. The viewer thinks that he/she wants to tell about the jacket to a friend so that he/she speaks “nice jacket” near the remote controller 32.

Thereupon, the voice is inputted to the voice recognition unit 107 through the microphone 32d. The voice recognition unit 107 records the time when the voice is inputted and the identification information of the program being viewed thereat, performs a recognition process of the voice (S101), and stores, into the time/recognition result table storage unit 106, in association, time information indicating the date, recognition result information indicating the voice recognition result and program information (S102). For example, the time information “16:27:05, Jan. 25, 2002”, the recognition result information “nice jacket” and the program identification information “AB1234” are stored into the time/recognition result table storage unit 106.

When the viewer finished or stopped watching the program, the information selection unit 105 i) reads the time information, recognition result information and program identification information that are stored in the time/recognition result table storage unit 106, ii) obtains the read program identification information and the program additional information associated with videos in the front and after and including the picture specified by the time information from the control unit 102, iii) performs language process and meaning analysis of the recognition result information, and iv) extracts object information (product information) corresponding to the recognition result information from the obtained program additional information (S103). Then, as an example of screen display shown in FIG. 13 (b), the information selection unit 105 outputs to present the extracted product information to the screen display unit 103, and encourages the viewer to verify and the destination to speak. For example, the information selection unit 105 obtains program additional information associated with pictures closer to the time “16:27:05, Jan. 25, 2002” of the program concerning the program identification information “AB1234” from the control unit 102, reads product information concerning the object “jacket” from the program additional information and outputs for display to the picture display unit 103.

In response to that, the viewer selects or inputs a destination using the destination input unit 110 after verifying that the interested product is displayed (S104). The information selection unit 105 which received a notification about the input from the transmission unit 108 reads a moving picture shot including the presented product information and voice from the control unit 102, and transmits it as tag information together with the product information. The transmission unit 108 then transmits the tag information to the destination specified by the viewer via the network (S105). For example, as shown in FIG. 13 (c), when the viewer speaks, “send it to B”, the voice is recognized by the destination input unit 110, and the transmission unit 108 specifies the destination of “B” with reference to the destination database 109 and transmits the tag information such as product information to the B “.

Here, in the case where a message from the viewer (e.g. voice message such as “I found a jacket suit to B, so I introduce it to you.”) is inputted via the destination input unit 110 and the like, the message is added to the tag information as an introducer message. Accordingly, the tag information to be transmitted from the broadcast receiving apparatus 31a to the third party includes video (moving picture)/sound data, program information (information such as program, broadcast station, broadcast date, casts, scenes and actors), product information (information such as product, size, color, material, price, time location and spatial location of the program in which the product appears), introducer information (identification information such as broadcast receiving apparatus 31a or telephone number and the like for identifying the viewer), and sound message of the introducer.

Thus, according to the broadcast receiving apparatus 31a in the present embodiment, when a viewer finds an object such as a commodity which he/she wants to introduce to the third party and an interested product while watching a program, the viewer only speaks to specify the product so that the time location and the object can be stored temporarily as attaching a tag to the program. Then, after finishing or stopping watching the program, the viewer verifies the video tagged by him/herself, specifies the destination by the speech and the like so that he/she can transmit the picture shot and the like in which the object appears, to the third party together with the object information. Consequently, the communication among viewers who talk about the object that appears in the program becomes smooth.

Also, the tag history concerning whether the viewer attached a tag to an object in a program, and the transmission history concerning which tag information is transmitted to the third party are notified from the broadcast receiving apparatus 31a to the broadcast receiving apparatus 31a to the broadcast station 20 and used for counting advertisement effect in the broadcast station 20.

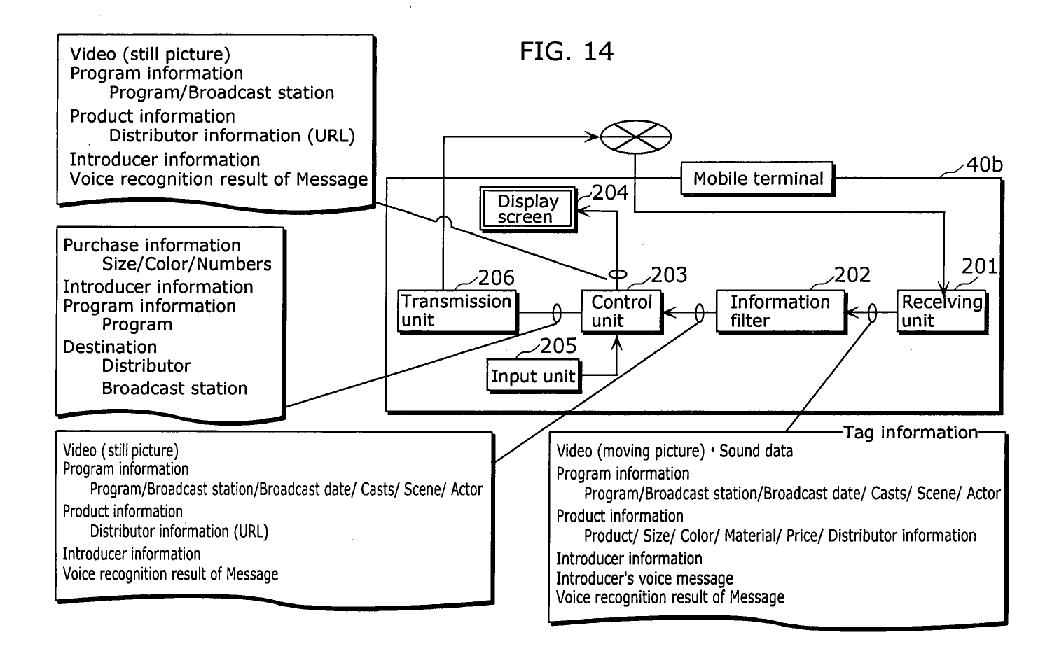

FIG. 14 is a functional block diagram showing a detailed structure of a mobile terminal 40b as an example of the communication apparatus which receives the tag information sent from the viewer. The mobile terminal 40b does not have a function of reproducing a moving picture and sound data, but is a simple PDA and the like having a function of accessing to a web site on the Internet. It is made up of a receiving unit 201, an information filter 202, a control unit 203, a display screen 204, an input unit 205 and a transmission unit 206.

The receiving unit 201 is a wireless communication interface and the like which receives tag information and the like transmitted from the broadcast receiving apparatus 31a via the network.

The information filter 202, from among the tag information received by the receiving unit 201, only selects data which can be processed by the mobile terminal 40b and transmits to the control unit 203, or converts the data in a format which the mobile terminal 40b cannot process into data available for the process. For example, in the case where the receiving unit 201 receives the moving picture and voice data, the information filter 202 i) abandons the moving picture and the voice data, ii) extracts a frame picture which composes a moving picture, converts it into a still picture and transmits to the control unit 203, or iii) recognizes the voice message in voice, converts it into a text message and transmits to the information filter 203.

The control unit 203 is a CPU and the like which displays the tag information transmitted from the information filter 202 on the display screen 204 and accesses to the distributor 60 based on an instruction to the display by an operator via the input unit 205. Specifically, in the case of obtaining a purchase instruction of a product from an operator is obtained while communicating with an operator via the display screen 204 and the input unit 205, the control unit 203 judges whether or not the purchase instruction is a purchase based on the tag information. When it is the purchase based on the tag information, the control unit 203 transmits the purchase information together with the introducer who sent the tag information and the tag information to the distributor 60. Here, the control unit 203 judges that a purchase is “purchase based on the tag information” in the case of purchasing a product by clicking and a URL and the like included in the tag information sent from the introducer and accessing the distributor 60 using an Internet browser and the like, or in the case of purchasing the product by accessing the URL and the like included in the tag information in a certain period (e.g. within three days) since the tag information is received.

The display screen 204 is a LCD and the like. The input unit 205 is buttons, a touch panel and the like. The transmission unit 206 is a wireless communication interface and the like which transmits purchase information and the like to the distributor 60 via the network.

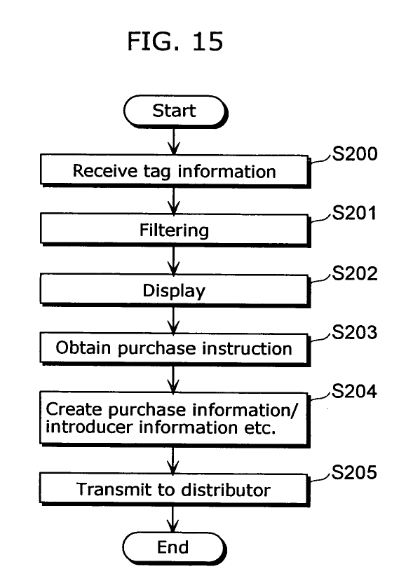

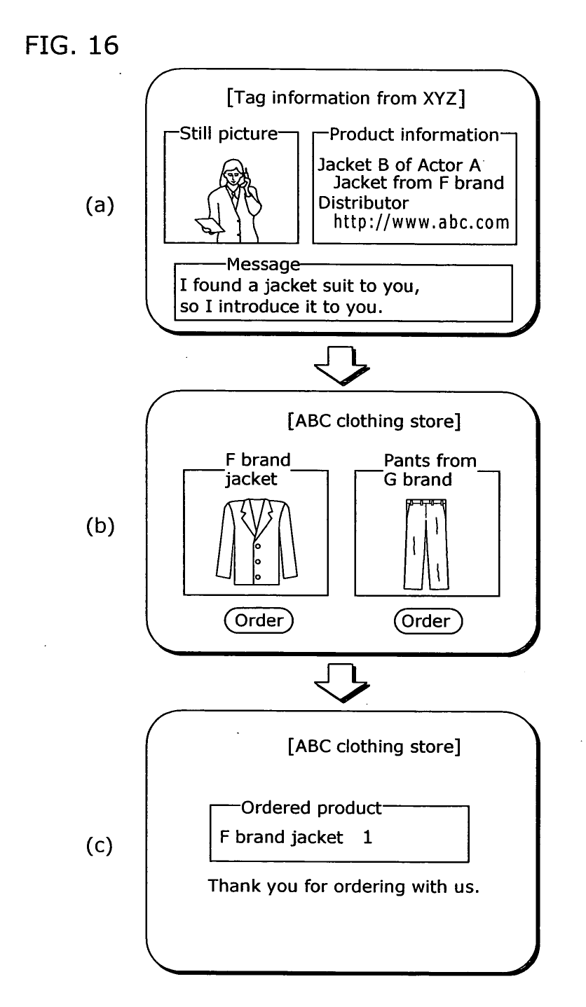

FIG. 15 is a flowchart showing operating procedure of the mobile terminal 40b which is structured as above described. FIG. 16 is a diagram showing a state of communication between the operator and the mobile terminal 40b When the tag information is sent from the broadcast receiving apparatus 31a, the receiving unit 201 of the mobile terminal 40b receives the tag information and transmits to the information filter 202 (S200).

The information filter 202, from among the tag information, selects data only available for the mobile terminal 40b and distributes it to the control unit 203, or converts data in a format which the mobile terminal 40b cannot process into available data (S201). For example, as a data example shown in FIG. 14, in the case where video (moving picture)/sound data, program information (program, broadcast station, broadcast date, casts, scenes, actors, etc.), product information (product, size, color, material, price, distributor information), introducer information, a voice message of the distributor, and a voice recognition result of the message are transmitted from the receiving unit 201, the information filter 202 transmits, to the control unit 203, only the video (still picture), the program information (program, broadcast station, broadcasting date, casts, scenes, actors, etc.), the product information (distributor information (URL)), the introducer information, and the voice recognition result of the message by converting the moving picture into the still picture and abandoning the sound data, a portion of the product information and the voice message of the distributor.

Following that, as a screen display example shown in FIG. 16 (a), the control unit 203 displays the tag information transmitted from the information filter 202 on the display screen 204 (S202). For example, it displays a name of the introducer at the head of the screen, the still picture at the left side of the screen, the product information at the right side of the screen, and the message from the introducer at the bottom of the screen.

In contrast, as an example of the screen displays shown in FIG. 16 (b) and (c), in the case where the operator accesses to the distributor 60 by clicking the URL of the distributor displayed on the display screen 204 and instructs to purchase a product through online shopping (S203), the control unit 203 judges it as a purchase based on the tag information transmitted from the introducer. Then, as an example of data shown in FIG. 14, the control unit 203 generates the introducer information and the program information and transmits to the transmission unit 206 (S204).

The transmission unit 206 transmits the transmission information transmitted from the control unit 203 to the distributor 60 (S205). Here, the distributor 60 which received the purchase information and the like performs ordering and reports the purchase information and the like as ordering information to the broadcast station 20. That is, the transmission unit 206 transmits the purchase information, the introducer information and the program information to the broadcast station 20.

Thus, according to the mobile terminal 40b in the present embodiment, the tag information transmitted from the introducer is selected only into data which the mobile terminal 40 b can process, or converted into data in a format which the mobile terminal 40b can process, and then the tag information is presented to the third party. Accordingly, the broadcast receiving apparatus 31a which transmits the tag information transmits the tag information as data in MPEG 7 format so that it can transmit various data without considering the receiving capability, data processing capability and the like of the destination apparatus.

Then, the third party who obtained the tag information, different from an introduction only through a conversion such as a telephone, can verify a product introduced by plentiful related information such as the detailed information about the product, the information concerning the program in which the product appears, and the picture. If the third party likes the product, he/she can accesses to the distributor 60 by a simple operation such as clicking the URL displayed on the screen, obtains further detailed information, and purchases the product therein. When such purchase of the product through the introducer is occurred, the notification about the purchase is fed back by the broadcast station 20 via the distributor 60 and used for counting the advertisement effect.

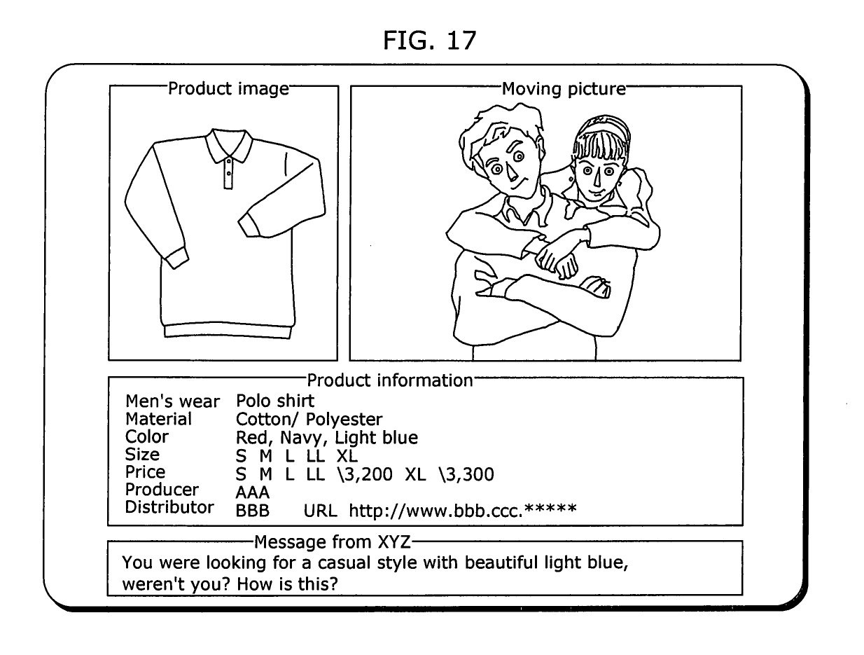

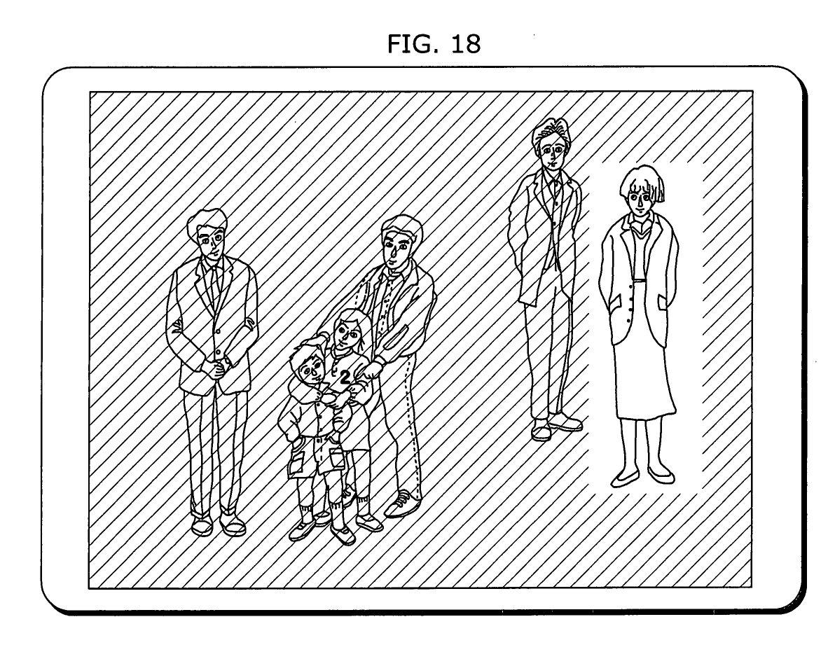

Note that, in the present embodiment, the mobile terminal 40b is a simple PDA and the like without having a function of reproducing a moving picture and voice data. However, in the case where the terminal apparatus which receives the tag information has a function of reproducing the moving picture as that of the mobile terminal 40a, for displaying the tag information, as an example of screen display shown in FIG. 17, not only the still picture such as a product image included in the tag information, but also the moving picture cut from the program (e.g. video for one scene including a scene in which the product appears) is displayed. Therein, as an example of a screen displayed shown in FIG. 18, in order to know a location of the object specified by the introducer, the object is displayed with highlight in the video. Such highlight display is based on information for the spatial location of the object included in the tag information.

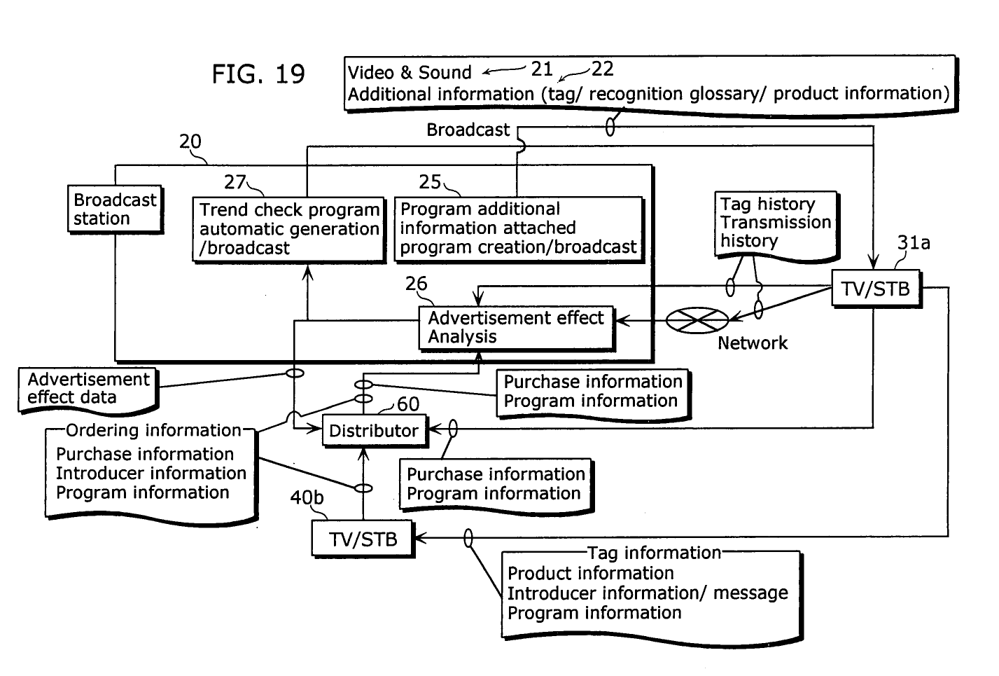

FIG. 19 is a diagram showing a detailed structure of the broadcast station 20 shown in FIG. 1 and peripheral apparatuses. The broadcast station 20 is a broadcast station capable of communicating in both ways such as a CATV, and made up of a program additional information attached program creation/broadcast unit 25, an advertisement effect analysis unit 26, and a trend check program automatic generation/broadcast unit 27.

The program additional information program creation/broadcast unit 25 is a computer apparatus, transmission apparatus and the like which produce, edit, and broadcast program contents for general broadcasting. It multiplexes and broadcasts the video/voice stream 21 shown in FIG. 1 with the program additional information 22. That is, it broadcasts the program in a data structure to which the viewer can attach a tag.

The advertisement effect analysis unit 26 is a computer apparatus and the like which receive ordering information (tag history, transmission history, purchase information, etc.) transmitted from the broadcast receiving apparatus 31a used by the viewer and the distributor 60, and analyze an advertisement effect based on the information.

The trend check program automatic generation/broadcast unit 27 is a computer apparatus, transmission apparatus and the like which automatically generate a trend check program by linking the advertisement effect analyzed by the advertisement effect analysis unit 26 and a previously produced program template, and broadcast toward a general viewer, a distributor, an advertiser and the like. For producing a trend check program, the trend check program automatic generation/broadcast unit 27, in response to the necessity, read a video of the relating program stored in the program additional information attached program creation/broadcast unit 25, and uses it as a material. Here, a program template is previously stored in a storage apparatus and the like included in the trend check program automatic generation/broadcast unit 27. For example, it includes a program progressing in a dialogue format with the viewer, a program progressing without obtaining an instruction from the viewer, a program which can review the program used for an advertisement, program in which the advertised product is introduced in detail, a program broadcasted with pay/free and the like.

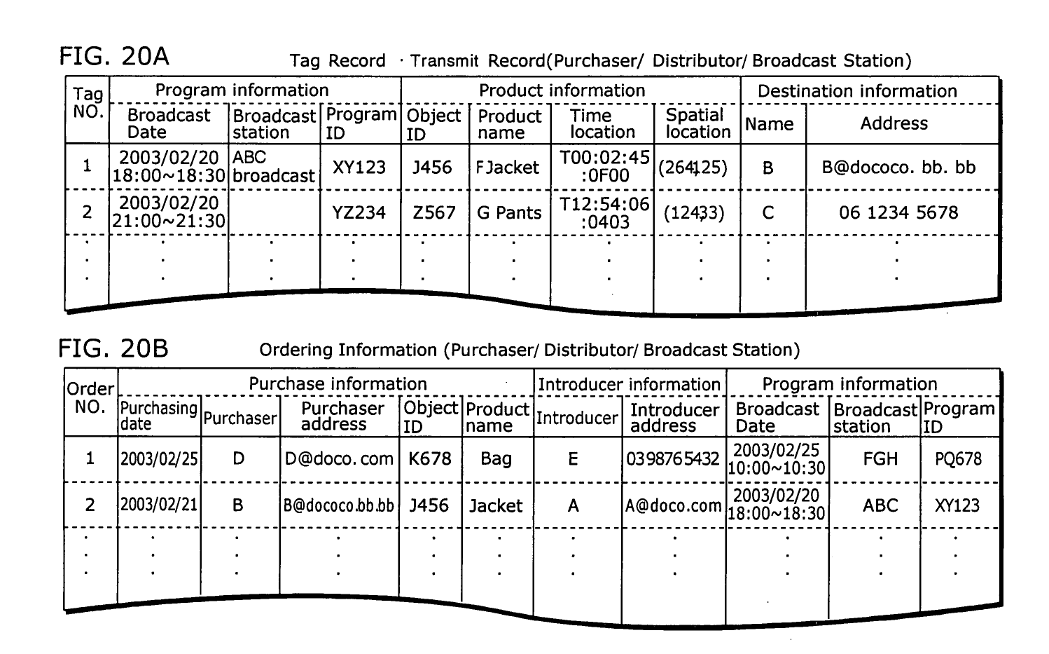

FIG. 20A is a diagram showing a data structure of a tag history (here shows a tag history including a transmission history) directly transmitted from the viewer (broadcast receiving apparatus 31a, etc.). FIG. 20B is a diagram showing a data structure of ordering information transmitted via the distributor 60 from the mobile terminal 40b and the like which purchased the product.

As shown in FIG. 20A, the tag history directly transmitted from the viewer, for example, is a set of tag information stored in a certain period of time. It includes “tag No.” for distinguishing individual tag information, “program information” for specifying a tagged program (“broadcast date”, “broadcast station”, and “program ID” for identifying a program”), “product information” for specifying the tagged object (“object ID” for identifying an object, “time location and “spatial location” of the appeared program), and “destination information” concerning a destination in the case where the tag information is transmitted to the third party (“destination” and “address”).

Also, as shown in FIG. 20B, the information transmitted from the distributor 60, for example, is a set of information concerning a purchase based on the introducer accumulated in a certain period of time. It includes “purchase information” concerning a purchase of the product (“purchase date”, “purchaser”, “object ID”, and “product title”), “introduction information” concerning a n introducer and the like (“name of introducer”, and “introducer address”), and “program information” concerning the program in which the introduced product appears (“broadcast date”, “broadcast station”, and “program ID”).

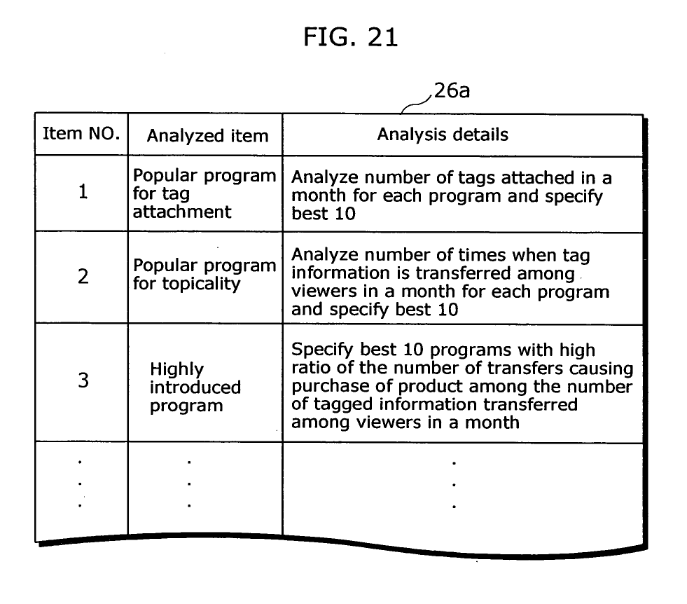

FIG. 21 is an analysis table 26a indicating types of analysis performed by the advertisement effect analysis unit 26. The advertisement effect analysis unit 26, as shown in an item 1 in the analysis table 26a, for example, collects tag histories from viewers, analyzes a number of tags attached in a month for each program, and specifies a “tag attachment popularity program” by specifying best 10. Also as shown in an item 2, by collecting transmission histories from the viewers, it complies for each program a number of times when the tag information is transferred among viewers and specifies the best 10 by specifying the “topic popularity program”. Further, as shown in an item 3, collecting and comparing the transmission histories from the viewers and the ordering information from the distributors 60, specifies a product which has highest number of probability to purchase the product (i.e. highest word-to-mouth effect program) among the number of times to transfer the tag information among viewers in a month, and specifies a “highest introduction effect program” by specifying the best 10.

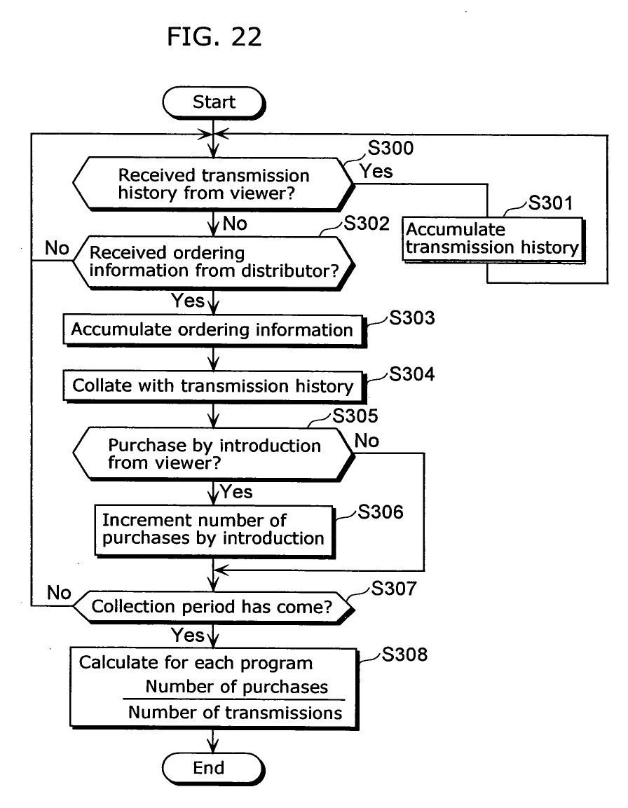

FIG. 22 is a flowchart showing a procedure concerning an analysis of an advertisement effect by the broadcast station 20 which is structured as described above. Here indicates a procedure concerning a specification of the item 3 “highest introduction effect program” shown in FIG. 21.

When the transmission history is transmitted from the viewer (Yes at S300), the advertisement effect analysis unit 26 receives the transmission history, stores it in association with program ID included therein. When the ordering information is transmitted from the distributor 60 (Yes at S302), it receives the ordering information and stores it in association with the program ID included therein (S303).

Then, the advertisement effect analysis unit 26 collates the received ordering information with the transmission history already received from the viewer (S304), and judges whether the purchase of the product shown in the transmitted ordering information (or individual ordering information included in the ordering information) is based on an introduction from other viewers or not (S305). For example, in the case where a purchaser name, purchaser address and object ID included in the ordering information transmitted from the distributor 60 match with a destination, address and object ID of the destination included in the transmission history transmitted from the viewer, the advertisement effect analysis unit 26 judges that the purchase is by the introduction from the viewer.

As the result, in the case where the purchase is judged as a purchase by the introduction from the viewer (S306), it increments a number counter corresponding to the program ID included in the ordering information (S306).

Then, when a collection period comes (e.g. first day of a month) (Yes at S307), the advertisement effect analysis unit 26 calculates, for each program, a ratio of a number of purchases by an introduction (number at Step S306) to the number of transmitting the tag information (number at Step S301) so as to specify the “highest introduction effect program” (S308). That is, for the product appeared in the program, it calculates a ratio of the number of products purchased from among those introduced from a viewer to the other viewer.

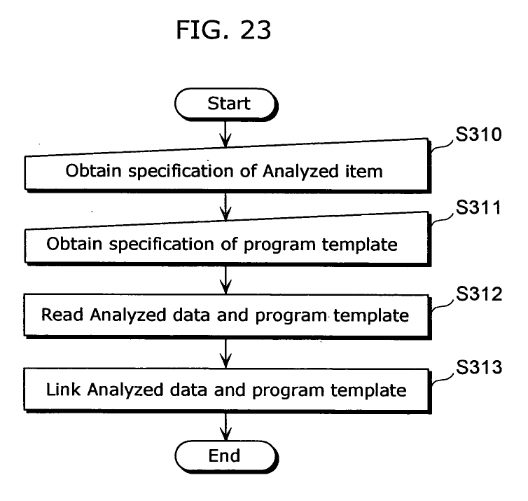

FIG. 23 is a flowchart showing a procedure for the broadcast station 20 to automatically generate a trend check program using the advertisement effect data analyzed as above described.

The trend check program automatic generation/broadcast unit 27, from a program editor, obtains an instruction to instruct one of the analyzed items shown in FIG. 21 (S310) and instruction to select one from among templates of the previously produced trend check programs (S311).

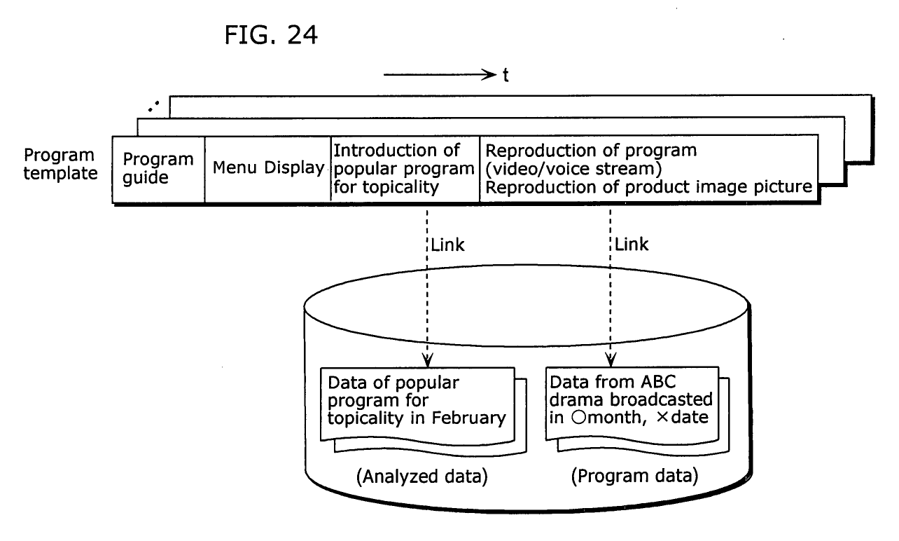

The trend check program automatic generation/broadcast unit 27 then reads an analysis result and a program template corresponding to those instructions respectively from the advertisement effect analysis unit 26 and internal storage apparatus (S312), and links to each other (S313). Herein, in the case where the program video/sound of the broadcast is combined as material into the trend check program, the trend check program automatic generation/broadcast unit 27 reads the video/sound data stored in the program additional information attached program creation/broadcast unit 25, links to each other similar to the analyzed data and completes the trend check program. Specifically, as shown in a data structure in FIG. 24, it generates a trend check program described in Broadcast Markup Language (BML), as a linking destination of reference data included in the program template, by setting the read data to the analyzed data read from the advertisement effect analysis unit 26, or by setting the read data to the program data read from the program addition information attached program creation/broadcast unit 25.

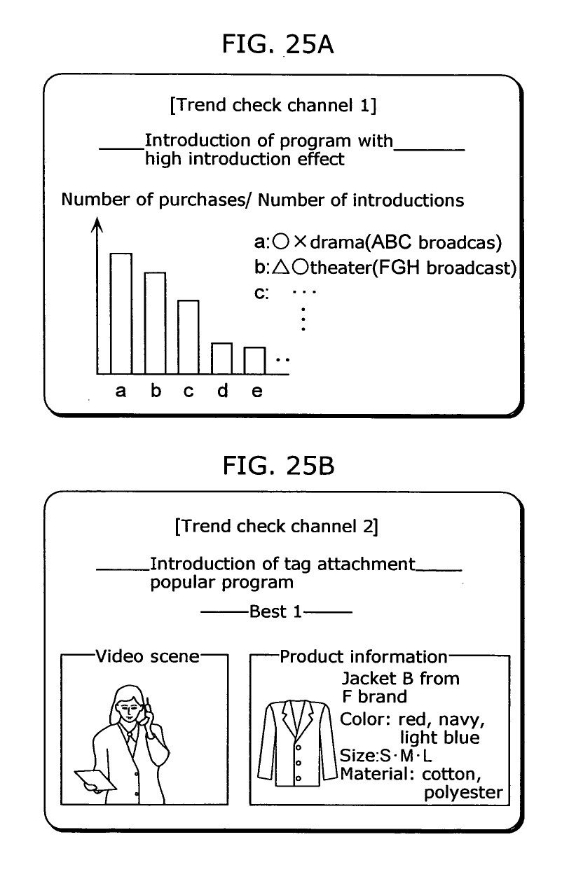

FIG. 25 is a diagram showing a display example of a program generated by the trend check program automatic generation/broadcast unit 27 as described above. FIG. 25A is a diagram showing an example of a screen of “introduction of the highest introduction effect program”. Here, among the number of programs in which the product appeared is introduced among viewers, the program with highest ratio of leading the purchase of the product, that is, the program with highest mouth-to-word effect is introduced. FIG. 25B indicates an example of a screen of “introduction of tag attachment popularity program”. Here, a product to which the viewer attached a tag most, that is, the highest topicality product and the program in which the product is appeared are introduced.

Through these trend check programs, for example, the advertiser can check an advertisement effect and use as information sources for determining a program to which newly advertisement expenses are invested.

Thus, according to the broadcast station 20 in the present invention, information concerning the tag and information concerning a purchase of the product are collected respectively from the viewer and the distributor 60, and broadcasted to the viewer, the advertiser and the like as trend check program after the advertisement effect (mouth-to-word effect) and the like based on the cause and effect relationship is analyzed. Accordingly, the viewer can know a program which is now in trend, a program with high topicality, a program which introduces popular products and the like. Also, the distributor and the adviser can check a program, video, scene, actor and the like with high advertisement effect and use them as a guide to a sales promotion.

In the above, it is explained about a delivery system according to the present invention based on the embodiment.

However, the present invention is not limited to the embodiment.

For example, whereas in the present invention, the tag information is transmitted directly from the viewer to the third party, it may be an indirect transfer via a server on a network. For example, it may be information transfer and the like via a mailing server, in which the viewer uploads the tag information to the server apparatus on the network and the third party downloads the tag information.

Also, in the present invention, an example of an object that appears in a program is a product such as a jacket. However, the object is not limited to a tangible object such as a commodity but also includes an intangible object such as copyrighted works like music used in the program and a service.

Further, in the present embodiment, both of the mobile terminal 40b and broadcast station 20 that received tag information judges whether or not the purchase of the product is through an introduction from another viewer. However, either of the mobile terminal 40b and the broadcast station 20 may make the judgement. For example, the broadcast station 20 may judge that the purchase of the product is by an introduction from the viewer in the case where the introduction destination and object name included in the transmission history transmitted from the viewer match with the purchaser and object name included in the purchase information transmitted from the distributor 60, and where those dates (introduction date and purchasing date) are occurred within a certain period of time.

Furthermore, in the present embodiment, the advertisement effect analysis unit 26 analyzes the number of tag attachments and transmission history of the tag information and the like for each program. However, the analysis may be performed for each object as a unit. That is, among the objects appeared in the program, the advertisement effect analysis unit 26 may analyze an object to which tags are attached most, an object which is introduced most to others as tag information, an object with highest probability to be purchased through an introduction, and the like may be analyzed. Accordingly, the advertisement effect can be checked not only for each program but also for each object as a unit.

Further, as an advertisement subsidiary activity, a service which adds a prize for those who introduce the product to others may be implemented. For example, when a person who received the tag information purchases the product, the advertiser and the like give a gift to those who sent the tag information. Consequently, the product introduction to others using tag information is activated.

Also, in the present invention, the information conversion unit 108e of the broadcast receiving apparatus 31a converts the voice message into a text message. However, in the case where the message of the viewer is inputted in text and the receiving apparatus at the destination has a voice reproduction function, the text massage may be synthesized in voice and converted into the voice message and outputted for reproduction.

Further, the information conversion unit 108e, not only performing a conversion of such data format, may reconstruct product information and the like described in a multimedia content description language such as MPEG 7 format, a language describing a markup of a document such as XML format, or the like corresponding to a display function at the destination, and transmit the reconstructed tag information to the third party. For example, the information conversion unit 108e converts into a picture or information for layout adjusting to a size of a display screen of a receiving apparatus at the destination. Consequently, a constraint for information conversion based on a difference of hardware of the transmission apparatus and the receiving apparatus are moderated.

Also, in the present embodiment, the product appeared in the program is introduced from the viewer to the third party. However, not only limited to products, a target to be introduced may be, for example, a program and the like. As a broadcast on demand, the third party who is introduced to the program can watch the program on demand when he/she likes the program. Consequently, an advertisement effect by mouth-to-word can be exerted for a paid program as well as the introduction of products.

Further, in the present embodiment, the broadcast station 20 analyzes an advertisement effect in a month, and reflects the effect to the trend check program. However, by complying an advertisement effect in a short term such as one day as a unit and providing to viewers, automatic generation and broadcasting of a program by which a program with high topicality and a trend of products and the like appeared in the program can be checked in real time are embodied.

Furthermore, in the present embodiment, the broadcast receiving apparatus 31a transmits the tag history and the transmission history to the broadcast station 20 after storing them for a month. However, the broadcast receiving apparatus 31a transmits the program information, product information and further tag information of a tagged object, to the broadcast station 20 at the same time when the viewer attaches a tag or when the tag information is transmitted to the third party, and the broadcast station 20 may store these information transmitted from the viewers in real time or analyze them in real time.

### INDUSTRIAL APPLICABILITY

The present invention can be used as a delivery system and the like which delivers a program through a television broadcasting and the like, in particular as a broadcast system and the like of a viewer information collecting type which analyzes information relating to the program based on information from viewers and the like while broadcasting the program.

1. A delivery system comprising a delivery apparatus which delivers a program, a receiving apparatus which receives the program, and a communication apparatus which can communicate with said receiving apparatus via a communication network,
wherein said receiving apparatus includes:
a tag unit operable to mark a specific portion of the received program or an object that appears in the program;
a first transmission unit operable to transmit, to said delivery apparatus, tag history information indicating a history concerning the marking by the tag unit; and
a second transmission unit operable to transmit tag information concerning the marked object to said communication apparatus, and
said delivery apparatus includes:
a first receiving unit operable to receive the tag history information transmitted from said receiving apparatus; and
an analysis unit operable to perform an analysis for the program based on the tag history information received by said first receiving unit.

2. The delivery system according to claim 1,
wherein said analysis unit is operable to count frequency of the marking for each program or object based on the tag history information, and specify a program or an object with a high marking frequency.

3. (canceled)

4. The delivery system according to claim 1,
wherein said first transmission unit is further operable to transmit, to said delivery apparatus, transmission history information indicating a history concerning the transmission of tag information to said communication apparatus by said second transmission unit,
said first receiving unit is further operable to receive the transmission history information transmitted from said receiving apparatus, and
said analysis unit is operable to count frequency of the transmission of the tag information for each program or object, and specify a program or object with a high marking frequency.

5. The delivery system according to claim 1, further comprising
a distributor apparatus which distributes online the object that appears in the program, said distributor apparatus being connected to said communication apparatus via the communication network,
wherein said communication apparatus includes:
a receiving unit operable to receive the tag information transmitted from said receiving apparatus; and
a purchase unit operable to purchase the object by communicating with said distributor apparatus, according to information concerning the object included in the tag information received by said receiving unit.

6. The delivery system according to claim 1,
wherein said communication apparatus further includes
a transmission unit operable to transmit purchase information concerning the purchase of the object to said delivery apparatus,
said delivery apparatus further includes
a second receiving unit operable to receive the purchase information transmitted from said communication apparatus, and
said analysis unit is operable to judge i) whether or not the object has been purchased based on the tag information transmitted from said receiving apparatus, by collating the purchase information received by said second receiving unit with the transmission history information received by said first receiving unit, and ii) in the case where the object has been purchased based on the tag information, and specify a program or object with high introduction effect by counting the frequency for each program or object.

7. The delivery system according to claim 6,
wherein the transmission history information includes information for specifying a destination of the tag information and the object,
the purchase information includes information for specifying said communication apparatus and the object, and
said analysis unit is operable to judge that the object is purchased based on the tag information in the case where the destination and the object that are indicated in the transmission history information match respectively to said communication apparatus and the object that are indicated in the purchase information.

8. The delivery system according to claim 1,
wherein said delivery apparatus further includes
a program creation unit operable to create a program using a result of the analysis obtained by said analysis unit as a material, and deliver the created program.

9. The delivery system according to claim 8,
wherein said program creation unit is operable to create the program by linking a previously produced program template and the result of the analysis.

10. The delivery system according to claim 1,
wherein said second transmission unit, according to a receiving function of said communication apparatus, is operable to select only a portion of the tag information, and transmit the selected information to said communication apparatus.

11. The delivery system according to claim 10,
wherein said second transmission unit is operable to convert a format of data, from one of a moving picture, a still picture, voice and text to another one of the formats, in accordance to the receiving function of said communication apparatus, the data being included in the tag information.

12. The delivery system according to claim 5,
wherein said communication apparatus further includes:
a selection unit operable to select only a portion of the tag information received by said receiving unit, according to functions concerning a display output and voice reproduction of said communication apparatus; and
a presentation unit operable to output the selected tag information for display or reproduce the selected tag information in voice.

13. The delivery system according to claim 12,
wherein said selection unit is further operable to convert a format of data, from one of a moving picture, a still picture, voice and text to another one of the formats, in accordance to the functions concerning the display output or voice reproduction of said communication apparatus, the data being included in the tag information received by said receiving unit.

14. A delivery apparatus, in a delivery system, which delivers a program, comprising said delivery apparatus and a receiving apparatus which receives the program, and a communication apparatus which can communicate with said receiving apparatus via a communication network,
wherein said receiving apparatus includes:
a tag unit operable to mark a specific portion of the received program or an object that appears in the program;
a first transmission unit operable to transmit tag history information indicating a history concerning the marking performed by said tag unit;
a second transmission unit operable to transmit tag information concerning the marked object to said communication apparatus, and
said delivery apparatus includes:
a first receiving unit operable to receive, from said receiving apparatus which receives the program, a specific portion of the program or tag history information indicating a history concerning the marking performed on the object that appears in the program; and
an analysis unit operable to perform an analysis for the program based on the tag history information received by said first receiving unit.

15. The delivery apparatus according to claim 14,
wherein said analysis unit, based on the tag history information, is operable to count frequency of the marking for each program or object, and specify a program or an object with high marking frequency.

16. The delivery apparatus according to claim 14,
wherein said receiving apparatus transmits, to said delivery apparatus, the tag history information indicating the history concerning the transmission of the tag information to said communication apparatus,
said first receiving unit is further operable to receive the transmission history information transmitted from said receiving apparatus, and
said analysis unit, based on the transmission history information, is operable to count frequency of the transmission of the tag information for each program or object, and specify a program or an object with high marking frequency.

17. The delivery apparatus according to claim 16,
wherein according to information concerning the object included in the tag information transmitted from said receiving apparatus, said communication apparatus is operable to perform a process for purchasing the object, and transmit purchase information concerning the purchase of the object to said delivery apparatus, by communicating with a distributor apparatus that is connected to said communication apparatus via a transmission path,
said delivery apparatus further comprises
a second receiving unit operable to receive the purchase information transmitted from said communication apparatus, and
said analysis unit is operable to judge whether or not the object is purchased based on the tag information transmitted from said receiving apparatus, by collating the purchase information received by said second receiving unit with the transmission history information received by said first receiving unit, and in the case where the object is purchased based on the tag information, specify a program or an object with high introduction effect by counting the frequency for each program or object.

18. The delivery apparatus according to claim 14, further comprising
a program creation unit operable to create a program using a result of an analysis obtained by said analysis unit, and deliver the created program.

19. An advertisement effect compilation method for analyzing an advertisement effect in a delivery system comprising a delivery apparatus which delivers a program, receiving apparatus which receives the program, and a communication apparatus which can communicate with said receiving apparatus via a communication network,
the method comprising steps A executed by said receiving apparatus and steps B executed by said delivery system, said steps A including:
a tag step of marking a specific portion of the received program or an object that appears in the program;
a first transmission step of transmitting tag history information indicating a history concerning the marking the tag step to said delivery apparatus; and
a second transmission step of transmitting tag information concerning the marked object, and
said steps B including:
a first receiving step of receiving the tag history information transmitted from said receiving apparatus; and
an analysis step of collecting the tag history information received in the first receiving step and analyzing for an advertisement effect of the program.

20. The advertisement effect compilation method according to claim 19,
wherein in the analysis step, a program or an object with high marking frequency is specified by counting frequency of the marking for each program or object.

21. The advertisement effect compilation method according to claim 19,
wherein in the first transmission step, transmission history information is further transmitted to said communication apparatus, the transmission history information indicating a history concerning the transmission of the tag information in the second transmission step,
in the first receiving step, the transmission history information transmitted from said receiving apparatus is further received, and
in the analysis step, based on the transmission history information, a program or object with a high marking frequency is specified by counting a frequency of transmission of the tag information for each program or object.

22. The advertisement effect compilation method according to claim 21,
wherein said delivery system further comprises
a distributor apparatus connected to said communication apparatus via the communication network, and operable to distribute the object that appears in the program,
said advertisement effect compilation method further comprising steps C executed by said communication apparatus, said steps C including:
a receiving step of receiving the tag information transmitted from said receiving apparatus;
a purchase step of performing a process for purchasing the object by communicating with said distributor apparatus, in accordance to information concerning the object included in the tag information received in the receiving step; and
a transmission step of transmitting purchase information concerning a purchase of the object to said delivery apparatus, and
said steps B executed by the delivery apparatus includes
a second receiving step of receiving the purchase information transmitted from said communication apparatus, and
in the analysis step, it is judged whether or not the object has been purchased based on the tag information transmitted from said receiving apparatus by collating the purchase information received in the second receiving step with the transmission history information received in the first receiving step, and in the case where the object has been purchased based on the tag information, a program or an object with high introduction effect is specified by counting the frequency for each program or object.

23. The advertisement effect-compilation method according to claim 22,
wherein the transmission history information includes information which specifies a destination of the tag information and the object,
in the analysis step, in the case where the destination and object indicated in the transmission history information match with said communication apparatus and object indicated in the purchase information, it is judged that the object has been purchased based on the tag information.
